(19) United States
(12) Patent Application Publication
(10) Pub. No.: US 2025/0030456 A1
(43) Pub. Date: Jan. 23, 2025

(54) WEARABLE RING DEVICE FOR MANAGING WIRELESS CHARGING AND NFC COMMUNICATION

(71) Applicant: CONZUMEX INDUSTRIES PRIVATE LIMITED, Bangalore (IN)

(72) Inventors: Prathyusha Kamarajugadda, Bangalore (IN); KLN SAI PRASANTH, Bangalore (IN)

(21) Appl. No.: 18/778,967

(22) Filed: Jul. 20, 2024

(30) Foreign Application Priority Data
Jul. 21, 2023 (IN) 202341049411
May 24, 2024 (IN) 202441040558

(51) Int. Cl. H04B 5/43; G06F 1/16; H02J 7/00; H02J 50/80; H04B 5/79

(52) U.S. Cl. CPC H04B 5/43; G06F 1/163; H02J 7/0047; H02J 50/80; H04B 5/79

(57) ABSTRACT

This patent application relates to a wearable ring device for managing wireless charging and NFC communication. The wearable ring device comprises ring body, shared antenna, physiological sensor, wireless charging controller, NFC controller and microcontroller. The ring body has an interior surface and an exterior surface. Shared antenna is placed at the interior surface of the ring body and perform both NFC communication and wireless charging. Physiological sensor detects whether wearable ring device is worn on finger of user. Further, wireless charging controller performs wireless charging of wearable ring device in wireless charging mode using shared antenna. Also, NFC controller performs NFC communication with external NFC-enabled devices in NFC communication mode using shared antenna. The microcontroller controls switching between wireless charging mode and NFC communication modes based on reception of physiological signal from physiological sensor, and performs one of wireless charging of wearable ring device or NFC communication using shared antenna.

### CROSS-REFERENCE TO RELATED APPLICATIONS

The present application claims priority from Indian Provisional Application Nos. 20/234,1049411 filed on 21 Jul. 2023, and 202441040558 filed on 24 May 2024 all of which are incorporated herein by reference.

### TECHNICAL FIELD

The proposed embodiments relate to a wearable technology and embedded systems. More particularly, the present disclosure relates to a wearable ring device for managing wireless charging and NFC communication.

### BACKGROUND OF INVENTION

The NFC technology has become increasingly popular in recent years due to its ability to enable contactless communication between devices. The NFC is also being integrated into various everyday objects, such as key fobs, wristbands, and even clothing, to enable quick and easy interactions with other devices. Further, to NFC communication is performed by smart devices using an antenna. The antenna receives and transmits the signals with external NFC enabled devices to perform NFC communication. However, one of the challenges faced by manufacturers is the size of the antenna used in the NFC devices. The shared antenna size is relatively large compared to other wireless communication technologies due to the principle of inductive coupling used in NFC devices. This principle generates voltage/current in one coil due to a change in voltage/current in another coil. As a result, the size of the shared antenna used in a typical NFC device is approximately 30 mm*50 mm.

Wireless charging is another technology that has gained significant attention in recent years. It is based on the principle of magnetic induction to transfer power for charging. However, the size of the antenna required for wireless charging is considerably larger than that of an NFC device. Wireless charging works at frequencies as low as 120 KHz, which means that the antenna size required for wireless charging is much larger than that of an NFC device. This poses a challenge for manufacturers as it is difficult to place two antennas, the wireless charging antenna and the NFC antenna, in a limited space.

The integration of wireless charging and the NFC communication capabilities in small-sized devices is a complex and challenging task that requires careful consideration of various factors. One of the primary challenges is the limited space available for multiple antennas, which can compromise the performance of both the wireless charging and the NFC communication. This is particularly true for wearable devices, which are becoming increasingly popular among consumers.

The wearable ring, are designed to be compact and lightweight, which means that there is limited space for placing multiple antennas. This can result in interference between the wireless charging and the NFC signals, which can lead to reduced performance and reliability. Additionally, the design of wearable ring is often compromised by the need to accommodate multiple antennas, which can detract from the overall aesthetic appeal of the device.

Another challenge faced by existing technology is the limited ability of wearable ring to perform both the wireless charging and the NFC communication simultaneously. This is due to the fact that both technologies require different frequencies and power levels, which can be difficult to manage in a small-sized device. As a result, many wearable ring are designed to perform one function at a time, which can be inconvenient for users who need to switch between different modes of operation.

Hence in the conventional wearable ring, the integration of wireless charging and secure NFC communication capabilities in small-sized wearable devices is a complex and challenging task that requires careful consideration of various factors. While existing technology has made significant strides in this area, there is still much work to be done to overcome the challenges posed by limited space, interference, and design aesthetics. As wearable devices continue to gain popularity, it is essential to develop innovative technical solutions that meet the needs of consumers while maintaining enhanced performance and reliability.

This gap in the current system underscores the need for improved solutions to address these disadvantages, issues, or other shortcomings, or at least to provide a useful alternative.

### SUMMARY OF THE INVENTION

The principal object of the embodiments herein is to provide a wearable ring device for managing wireless charging and NFC communication with a single shared antenna.

Another object of the invention is to provide a controlled mechanism between the wireless charging and the NFC communication with a shared antenna in the wearable ring device.

Yet another object of the invention is to provide a wearable ring device with a shared antenna designed to perform both wireless charging and NFC communication.

Yet another object of the invention is to control MOSFET switches of the wireless charging side once an input signal is received from the proximity sensor to disable wireless charging mode and enable NFC communication.

Yet another object of the invention is to control MOSFET switches of the NFC side to ground or open the NFC circuit and to maintain the connection between the wireless charging circuit and the battery with the shared antenna to disable NFC communication mode and enable wireless charging mode.

Yet another object of the invention is to enable a signal to the Haptic controller for delivering power to a haptic motor to provide feedback to the user.

Yet another object of the invention is to perform seamless switching between NFC communication and NFC charging in wearable rings upon receiving an input signal from the skin proximity sensor.

In one aspect, the objectives are achieved by providing a wearable ring device for managing wireless charging and NFC communication. The wearable ring device comprises a ring body, a shared antenna, a physiological sensor, a wireless charging controller, an NFC controller and a microcontroller. The ring body is adapted to be worn on a finger of a user. The ring body has an interior surface and an exterior surface. The shared antenna is placed at the interior surface of the ring body. The shared antenna is configured to perform both the NFC communication and wireless charging. The physiological sensor detects whether the wearable ring device is worn on the finger of the user. Further, the wireless charging controller performs the wireless charging of the wearable ring device in a wireless charging mode using the shared antenna. Further, the NFC controller performs the NFC communication with external NFC-enabled devices in a NFC communication mode using the shared antenna. Further, the microcontroller is connected to the physiological sensor, the wireless charging controller, NFC controller, and the shared antenna. The microcontroller controls switching between the wireless charging mode and the NFC communication modes based on reception of the physiological signal from the physiological sensor. Further, the microcontroller performs one of the wireless charging of the wearable ring device using the shared antenna or the NFC communication with the external NFC-enabled devices using the shared antenna.

In an embodiment, to control switching between the wireless charging mode and the NFC communication mode based on the physiological signal is received from the physiological sensor, the wearable ring device determines whether the physiological signal is received from the physiological sensor. The reception of the physiological signal indicates that the wearable ring device is worn on the finger of the user. Further, the wearable ring device automatically switches from the wireless charging mode to the NFC mode and perform the NFC communication with the external NFC-enabled devices using the shared antenna, when the physiological signal is received from the physiological sensor. Also, the wearable ring device automatically switches from the NFC mode to the wireless charging mode and performs the wireless charging of the wearable ring device using the shared antenna, when the physiological signal is not received from the physiological sensor.

In an embodiment, the automatic switch from the wireless charging mode to the NFC mode comprises automatically disabling the wireless charging controller and enables the NFC controller to perform the NFC communication using the shared antenna.

In an embodiment, to automatically switch from the NFC mode to the wireless charging mode the wearable ring device automatically disable the NFC controller and enable the wireless charging controller to perform the wireless charging using the shared antenna.

In an embodiment, the shared antenna is oriented towards a opposite of the finger of the user of the wearable ring device, and wherein position and orientation of the shared antenna maximizes a signal strength of the shared antenna during the NFC communication while minimizing exposure to external interferences.

In an embodiment, the physiological sensor comprises at least one of an optical-based skin sensor, a capacitance-based skin sensor, an inductance based skin sensor, and a force-based skin sensor.

In an embodiment, a haptic controller is connected to the microcontroller. The haptic controller receives input signals from the microcontroller when the microcontroller switches between the NFC mode and the wireless charging mode and generates a haptic feedback for the user regarding the switching based on the received input signals. Further, a memory is connected to the microcontroller, wherein the memory stores information related to the wireless charging and NFC communication modes. Further a battery of the wearable ring device connected to the wireless charging controller via a sixth connection. Further, an actuator is connected to the microcontroller that performs manual activation or deactivation of the wireless charging mode and the NFC communication mode.

In an embodiment, the wearable ring device comprises a first connection that operatively connects gates of MOSFETs associated with the wireless charging controller with the microcontroller. The MOSFETs is controlled by the microcontroller based on the physiological signals received from the physiological sensors. Further a second connection that operatively connects gates of the MOSFETs associated with NFC controller with the microcontroller. The MOSFETs is controlled by the microcontroller based on the physiological signals received from the physiological sensors. Also, the wearable ring device comprises a third connection that operatively connects the microcontroller to the physiological sensor. Further, comprises a fourth connection that operatively connects the MOSFETs associated with the wireless charging controller to the shared antenna. Further, the wearable ring device comprises a fifth connection that operatively connects the MOSFETs associated with the NFC controller to the shared antenna. When the physiological signals are not received from the physiological sensor via the third connection, the microcontroller disables the NFC controller via the second connection and turns on the MOSFET switches, thereby disabling antenna portion of the NFC controller and enabling wireless charging controller by opening its antenna connection through the fourth connection. Also, the when input signals are received from the physiological sensor via the third connection, the microcontroller disables the wireless charging controller via the first connection and turns off the MOSFET switches by putting the MOSFET switches to ground, thereby disabling the antenna portion of the wireless charging controller and enabling the NFC controller by opening its antenna connection through fifth connection.

In an embodiment, the wearable ring device comprises a first communication link that operably connects the haptic controller to the microcontroller. The first communication link is configured to enable I2C communication between the microcontroller, the wireless charging controller, and the haptic controller. Further, the wearable ring device comprises a second communication link (HAP-GPIO connection) is connected to the microcontroller. The haptic controller sends the haptic feedback signals to the microcontroller indicating completion of the haptic event, or any event detected by the haptic controller. The wireless charging controller is configured to receive signals from the microcontroller via the first communication link or second communication link to enable the wireless charging of the wearable ring device, and to disable the wireless charging and enable the NFC communication.

In an embodiment, the wearable ring device comprises a first matching circuit and a second matching circuit. The first matching circuit is connected to the wireless charging controller through two pin connections and connected to the shared antenna via two terminal connections. The first matching circuit optimizes impedance matching between a shared antenna and the wireless charging controller. Also, the first matching circuit controls efficient transfer of power between the shared antenna and the wireless charging controller. Further, the second matching circuit connected to the NFC controller through 4 pin connections. The second matching circuit is further connected to the shared antenna through two terminal connections. The second matching circuit controls efficient transfer of data between the shared antenna and the NFC controller. Also, the second matching circuits configured to receive input and output through the 4 pin connections. Further when enabled, the wireless charging controller performs charging of the wearable ring device using the shared antenna through the two terminal connections.

In an embodiment, the wireless charging controller comprises a rectifier circuit, a filter circuit and a voltage regulator. The filter circuit is configured to rectify an AC voltage received from a wireless power transmitter. Also, the rectifier circuit includes diodes that rectify the AC voltage. Further, the filter circuit is configured to filter the rectified voltage to remove high-frequency noise. The filter circuit including capacitors that filter out the high-frequency noise. Further, the voltage regulator is configured to regulate the filtered voltage to a constant level.

In an embodiment, the wireless charging controller comprises a power management unit (PMU). The PMU is configured to regulate the AC voltage received from a wireless power transmitter. Further, the PMU is configured to monitor a status of a battery of the wearable ring device. Further, the PMU is configured to detect whether the battery being fully charged based on the monitored status of the battery. Further, the PMU is configured to deactivate the wireless charging of the wearable ring device to prevent overcharging, when the battery being fully charged.

In an embodiment, the NFC controller comprises a demodulator. The demodulator is configured to demodulate a received signal from the shared antenna. Further, the demodulator extracts data from the received signal and sends the extracted data to a microcontroller for further processing. Further, the demodulator modulates data to be transmitted to the shared antenna during the NFC communication by changing an amplitude or phase of a carrier signal.

In an embodiment, the haptic controller comprises a haptic actuator that generates vibrations of different intensities and frequencies based on input received from the microcontroller. Further, the haptic controller comprises a driver circuit that amplifies signals from the microcontroller to drive the vibration motor. Also, the haptic controller comprise a dedicated bidirectional communication interface between the haptic controller and the microcontroller, comprising multiple pins configured to transmit and receive digital signals encoded using a specific protocol.

In an embodiment, the shared antenna is having a communication range of 3 centimeter.

In an embodiment, the shared antenna operates at a frequency of 13.56 MHz to perform the wireless charging of the wearable ring device.

In an embodiment, the shared antenna operates at a frequency of 13.56 MHz to perform the NFC communication with the external NFC-enabled devices.

In an embodiment, the ring body is constructed from a fully metallic material or a partially metallic material or a non-metal.

Accordingly, the embodiment herein is to provide a method for managing wireless charging and NFC communication. The method includes selecting by a wearable ring device, a configuration of a shared antenna between a wireless charging controller and a NFC controller of the wearable ring device. Further, the method includes determining, by the wearable ring device, whether a physiological signal is received from a physiological sensor positioned within a ring body of the wearable ring device. The reception of the physiological signal indicates that the wearable ring device is worn on a finger of a user of the wearable ring device. Further, the method includes automatically switching, by the wearable ring device, from the wireless charging mode to the NFC mode and performing by the wearable ring device the NFC communication with external NFC-enabled devices using the shared antenna, when the physiological signal is received from the physiological sensor. Further, the method includes automatically switching, by the wearable ring device, from the NFC mode to the wireless charging mode and performing the wireless charging of the wearable ring device using the shared antenna between the wireless charging controller and the NFC controller, when the physiological signal is not received from the physiological sensor.

In an embodiment, the method of automatically switching from the wireless charging mode to the NFC mode comprises automatically disabling the wireless charging controller and enabling the NFC controller to perform the NFC communication using the shared antenna. Further, the method of automatically switching from the NFC mode to the wireless charging mode comprises automatically disabling the NFC controller and enable the wireless charging controller to perform the wireless charging using the shared antenna.

In an embodiment, the method of automatically switching from the wireless charging mode to the NFC communication is based on at least one of detecting and generating a haptic feedback signal through the second communication link when the haptic actuator is pressed by the user or receiving an external input from the user using the I/O interface.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications be made within the scope of the embodiments herein.

### DESCRIPTION OF THE DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is a block diagram that illustrates a wearable ring device for wireless charging and secured NFC communication with a shared antenna operating with a controlled switching mechanism, according to the disclosed embodiments.

FIG. 2A is a schematic figure that illustrates a wearable ring device for wireless charging and secured NFC communication with a shared antenna operating with a controlled switching mechanism, according to the disclosed embodiments.

FIG. 2B is a schematic figure that illustrates the shared antenna in the wearable ring device for switching between the wireless charging controller and NFC controller, according to the disclosed embodiments.

FIG. 2C is a schematic figure that illustrates the shared antenna and battery of the wearable ring device to switch between the wireless charging controller and NFC controller, according to the disclosed embodiments.

FIG. 2D is a schematic figure that illustrates the top view of the shared antenna in the wearable ring device, according to the disclosed embodiments.

FIG. 2E is a schematic figure that illustrates a cross-sectional view of the shared antenna in the wearable ring device, according to the disclosed embodiments.

FIG. 2F is a schematic figure that illustrates the shared antenna region in the wearable ring device, according to the disclosed embodiments.

FIG. 2G is a schematic figure that illustrates the skin proximity sensor region in the wearable ring device, according to the disclosed embodiments.

FIG. 2H is a schematic figure that illustrates the NFC controller placed in the wearable ring device, according to the disclosed embodiments.

FIG. 2I is a schematic figure that illustrates the wireless charging controller on the wearable ring device, according to the disclosed embodiments.

FIG. 3A is a schematic diagram that illustrates the circuit connection of the wearable ring device for wireless charging and secured NFC communication with a shared antenna operating with a controlled switching mechanism, according to the disclosed embodiments.

FIG. 3B is a schematic diagram that illustrates the enablement of the NFC controller to perform NFC communication using shared antenna, according to the disclosed embodiments.

FIG. 3C is a schematic diagram that illustrates the enablement of wireless charging controller to perform wireless charging using shared antenna, according to the disclosed embodiments.

FIG. 4 is a circuit diagram that illustrates a wearable ring device for wireless charging and secured NFC communication with a shared antenna operating with a controlled switching mechanism, according to the disclosed embodiments.

FIG. 5 is a block diagram that illustrates a microcontroller for controlling the switching between wireless charging and NFC communication with a shared antenna, according to the disclosed embodiments.

FIG. 6 is a circuit diagram that illustrates the connection of the skin proximity sensor with the microcontroller, according to the disclosed embodiments.

FIG. 7 is a circuit diagram that illustrates the wireless charging controller connected to the microcontroller, according to the disclosed embodiments.

FIG. 8 is a circuit diagram that illustrates the NFC controller connected to the microcontroller, according to the disclosed embodiments.

FIG. 9 is a circuit diagram that illustrates the Haptic controller connected to the microcontroller, according to the disclosed embodiments.

FIG. 10 is a flow diagram that illustrates a method for managing wireless charging and NFC communication, according to the disclosed embodiments.

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the invention. Further, the elements may have been represented in the drawing by conventional symbols, and the drawings may show only those specific details that are pertinent to understanding the embodiments of the invention so as not to obscure the drawing with details that will be readily apparent to those of ordinary skill in the art having the benefit of the description herein.

### DETAILED DESCRIPTION OF THE INVENTION

It may be noted that, to the extent possible, like reference numerals have been used to represent like elements in the drawing. Furthermore, those of ordinary skill in the art will appreciate that elements in the drawing are illustrated for simplicity and may not necessarily have been drawn to scale. For example, the dimensions of some of the elements in the drawing may be exaggerated relative to other elements to improve the understanding of aspects of the invention. Further, the elements may have been represented in the drawing by conventional symbols, and the drawings may show only those specific details that are pertinent to understanding the embodiments of the invention so as not to obscure the drawing with details that will be readily apparent to those of ordinary skill in the art having the benefit of the description herein.

As is traditional in the field, embodiments are described and illustrated in terms of blocks that carry out a described function or functions. These blocks, which are referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by firmware and software. The circuits, for example, may be embodied in one or more semiconductor chips or on substrate supports such as printed circuit boards and the like. The circuits constituting a block may be implemented by dedicated hardware or by a processor (e.g., one or more programmed microprocessors and associated circuitry) or by a combination of dedicated hardware to perform some functions of the block and a processor to perform other functions of the block. Each block of the embodiments may be physically separated into two or more interacting and discrete blocks without departing from the scope of the proposed method. Likewise, the blocks of the embodiments may be physically combined into more complex blocks without departing from the scope of the proposed method.

The accompanying drawings are used to help easily understand various technical features, and it is understood that the embodiments presented herein are not limited by the accompanying drawings. As such, the proposed method is construed to extend to any alterations, equivalents, and substitutes in addition to those which are particularly set out in the accompanying drawings. Although the terms “first,” “second,” etc. are used herein to describe various elements, these elements are not limited by these terms. These terms are generally used to distinguish one element from another.

Accordingly, the embodiments discloses a wearable ring device for managing wireless charging and NFC communication. The wearable ring device comprises a ring body, a shared antenna, a physiological sensor, a wireless charging controller, an NFC controller and a microcontroller. The ring body is adapted to be worn on a finger of a user. The ring body has an interior surface and an exterior surface. The shared antenna is placed at the interior surface the ring body. The shared antenna is configured to perform both the NFC communication and wireless charging. The physiological sensor detects whether the wearable ring device is worn on the finger of the user. Further, the wireless charging controller performs the wireless charging of the wearable ring device in a wireless charging mode using the shared antenna. Further, the NFC controller performs the NFC communication with external NFC-enabled devices in a NFC communication mode using the shared antenna. Further, the microcontroller is connected to the physiological sensor, the wireless charging controller, NFC controller, and the shared antenna. The microcontroller controls switching between the wireless charging mode and the NFC communication modes based on reception of the physiological signal from the physiological sensor. Further, the microcontroller performs one of the wireless charging of the wearable ring device using the shared antenna or the NFC communication with the external NFC-enabled devices using the shared antenna.

Accordingly, the embodiment herein is to provide a method for managing wireless charging and NFC communication. The method includes selecting, by a wearable ring device, a configuration of a shared antenna between a wireless charging controller and a NFC controller of the wearable ring device. Further, the method includes determining, by the wearable ring device, whether a physiological signal is received from a physiological sensor positioned within a ring body of the wearable ring device. The reception of the physiological signal indicates that the wearable ring device is worn on a finger of a user of the wearable ring device. Further, the method includes automatically switching, by the wearable ring device, from the wireless charging mode to the NFC mode and performing by the wearable ring device the NFC communication with external NFC-enabled devices using the shared antenna, when the physiological signal is received from the physiological sensor. Further, the method includes automatically switching, by the wearable ring device, from the NFC mode to the wireless charging mode and performing the wireless charging of the wearable ring device using the shared antenna between the wireless charging controller and the NFC controller, when the physiological signal is not received from the physiological sensor.

The proposed invention provides a wearable ring device for performing both the wireless charging and the NFC communication using the shared antenna with reduced complexity and less utilization of resources. The reduced complexity leads to increase in the lifetime of the battery. Particularly, the microcontroller of the proposed wearable ring puts the wireless charging controller or the NFC controller to ground or keeps the outputs open, to switch between the operation of wireless charging and NFC, thereby reducing the complexity in switching operation and transmission of control signals between the two ICs for switching. Also, the proposed invention enhances the performance speed of the wearable ring.

The wearable ring device is equipped with a wireless charging mechanism that that enables the user to charge the device without the need for any cables or wires. This feature of the wearable ring device makes it more convenient for users who are always on the go and do not have the time to sit and charge their devices. The wearable ring device is also designed to be more secure, with NFC communication that is protected by a secure protocol. This ensures that the user's personal information is kept safe and secure at all times. The shared antenna feature of the wearable ring device is another innovative aspect of the technology. This allows for the device to be more compact and lightweight, as it does not require multiple antennas for different functions. The controlled switching mechanism ensures that the wearable ring device operates smoothly and efficiently, without any interference or interruption to the wireless charging or NFC communication functions.

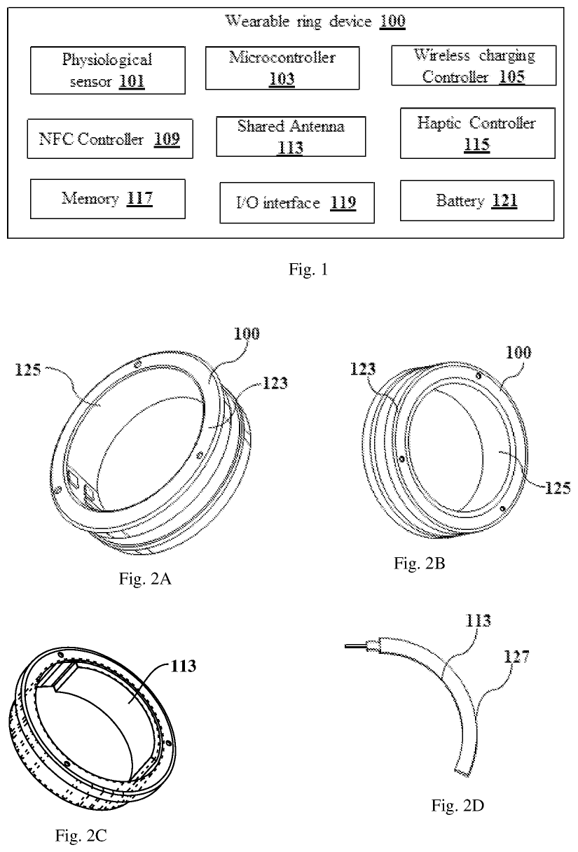

FIG. 1 is a block diagram that illustrates a wearable ring device for wireless charging and secured NFC communication with a shared antenna operating with a controlled switching mechanism according to the disclosed embodiments.

The wearable ring device (100) is a small, ring shaped electronic device that is designed to be worn on a finger. The wearable ring device (100) can be connected to smartphones or other electronic devices via NFC communication to provide seamless integration and data synchronization. The wearable ring device (100) comprises a physiological sensor (101), a microcontroller (103), wireless charging controller (105), a NFC controller (109), a shared antenna (113), a haptic controller (115), a memory (117), an I/O interface (119), and a battery (121). The microcontroller (103) is interactively connected with the physiological sensor (101), the wireless charging controller (105), the NFC controller (109), and the haptic controller (115).

The wearable ring device comprises a ring body that is adapted to be worn on a finger of a user. The ring body has an interior surface and an exterior surface.

The physiological sensor (101) measures physiological signals of a body of the user who worn the wearable ring device (100). In an embodiment, the physiological sensor (101) is a skin proximity sensor that measures whether the wearable ring device (100) is worn by the user or not. This sensor is an essential component of the wearable ring device (100) as it ensures that the wearable ring device (100) is only collecting data when it is in contact with the user's skin. The skin proximity sensor works by detecting changes in the skin's electrical conductivity. When the wearable ring device (100) is in contact with the skin, it creates a closed circuit, and the sensor can measure the electrical signals generated by the body. These signals are then processed by the microcontroller (103), which determines whether the wearable ring device (100) is being worn by the user or not.

If the wearable ring device (100) is not in contact with the skin, it will not collect any data, thus conserving battery life. The use of skin proximity sensors in wearable ring device (100) has several advantages. First, it ensures that the wearable ring device (100) is only collecting data when it is in contact with the user's skin, thus reducing the risk of false readings. Second, it helps conserve battery life by only collecting data when the wearable ring device (100) is being worn. Finally, it provides a more accurate picture of the user's physiological signals, as the sensor is in direct contact with the skin, which is the most reliable source of physiological data. Overall, the use of physiological sensor in wearable ring device (100) has transformed the way we monitor our health and well-being, and the skin proximity sensor is a important component of this technology.

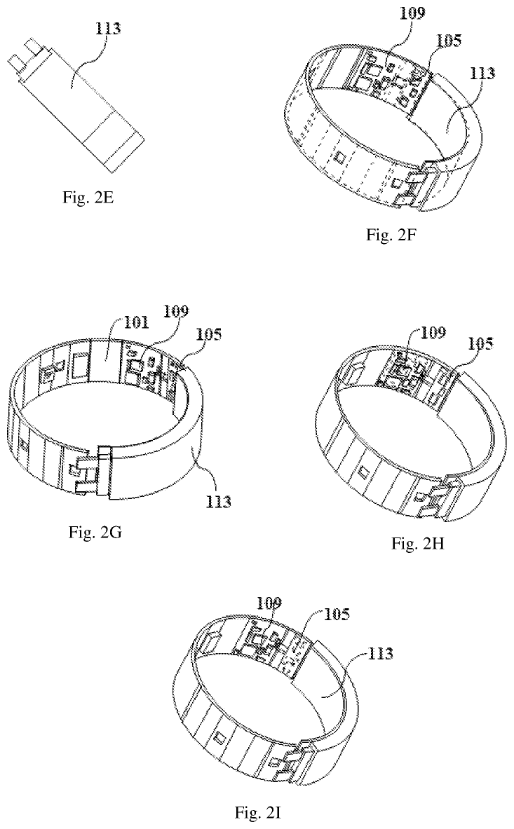

In an embodiment, the skin proximity sensor is placed at the inner surface of the wearable ring device (100) as shown in FIG. 2G. The placement of the skin proximity sensor at the inner surface of the wearable ring device (100) has several advantages. Firstly, it allows for accurate detection of whether the wearable ring device (100) is being worn by the user or not. This is important for a number of reasons, including ensuring that the wearable ring device (100) is functioning properly and that the user is receiving the benefits of the wearable ring device (100). Without accurate detection of whether the wearable ring device (100) is being worn, the wearable ring device (100) may not be functioning properly or may not be providing the intended benefits to the user.

Secondly, the placement of the skin proximity sensor at the inner surface of the wearable ring device (100) also allows for greater comfort for the user. By placing the skin proximity sensor at the inner surface, the device can be designed to be more ergonomic and less obtrusive, making it more comfortable for the user to wear for extended periods of time. This is particularly important for wearable ring device (100) that are intended to be worn for extended periods of time, such as fitness trackers or health monitoring devices.

Further, the placement of the skin proximity sensor at the inner surface of the wearable ring device (100) also allows for greater durability and longevity of the device. This can help to ensure that the wearable ring device (100) remains functional and effective for a longer period of time, reducing the need for repairs or replacements.

Further, the microcontroller (103) is connected to the physiological sensor (101), the wireless charging controller (105), the NFC controller (109) and the Haptic controller (115). The microcontroller (103) enables the operation of the wireless charging of the wearable ring device (100), when there is no input signals received from the physiological sensor (101). The wearable ring device (100) in default mode operates in the wireless charging mode. In an embodiment, when the wearable ring device (100) is worn by the user, the microcontroller (103) receives the physiological signal from the physiological sensor (101) through a third connection and switches from the wireless charging mode to the NFC communication mode.

Further based on the switching the operations performed by the microcontroller (103) and the shared antenna (113) which was previously used for wireless charging will now be used for performing the NFC communications. The microcontroller (103) is programmed to switch between wireless charging and NFC communication modes based on the input signals received from the physiological sensor (101) or the input received from users of the wearable ring device (100). The shared antenna (113) is a dual-mode shared antenna (113) that is capable of transmitting and receiving signals for both wireless charging and NFC communication. The shared antenna (113) is designed to optimize the signal transmissions for performing the dual NFC communication and wireless charging.

The shared antenna (113) is used for both the wireless charging and the NFC communication in the wearable ring device (100). The shared antenna (113) is positioned at an inner surface of the wearable ring device (100) and at the top of the metal part of the wearable ring device (100) as shown in FIG. 2C such that the shared antenna (113) can optimize the signal transmissions for performing the dual NFC communication and wireless charging. The shared antenna (113) is oriented towards a opposite side of the finger of the user of the wearable ring device (100). The shared antenna (113) is a loop shared antenna that is designed to operate at a frequency range of 13.56 MHz for NFC communication and for wireless charging. The shared antenna (113) is made of a conductive material such as copper or aluminum and is coated with a dielectric material to prevent interference from the metal part of the wearable ring device (100).

Also, the shared antenna (113) ensures that the outer metal circumference of the wearable ring device (100) do not restrict the NFC communication with the wearable ring device (100). The shared antenna (113) is designed to have a high Q factor, which means that it has a high efficiency in transmitting and receiving signals. The Q factor of the shared antenna (113) is maintained by minimizing the losses due to the proximity of the metal part of the wearable ring device (100). The shared antenna (113) is also designed to have a low profile, which means that it is thin and does not protrude from the surface of the wearable ring device (100).

The wireless charging controller (105) performs the wireless charging of the wearable ring device (100) using the shared antenna (113) when no input signals are received from the physiological sensor (101). The wireless charging controller (105) is a power management IC that is designed to regulate the power transfer between the shared antenna (113) and the battery of the wearable ring device (100). The wireless charging controller (105) is also designed to detect the presence of a compatible wireless charging pad and to adjust the power transfer accordingly.

The NFC controller (109) performs the NFC communication using the shared antenna (113) when the input signals are received from the physiological sensor (101) or when the input is received from the users of the wearable ring device (100). The NFC controller (109) is a communication IC that is designed to support the NFC protocol for data exchange between the wearable ring device (100) and other NFC-enabled devices such as smartphones or payment terminals. The NFC controller (109) is also designed to support the ISO/IEC 14443 standard for contactless smart cards and proximity cards. In an embodiment, the NFC controller contains a secure element using which one or more operations such as contactless payments and access control can be performed.

The Haptic controller (115) is a circuit that creates a sense of touch to the users when its interacting with the wearable ring device (100). The haptic controller (115) can be implemented using various types of actuators such as linear resonant actuators (LRAs), eccentric rotating mass (ERM) motors, or piezoelectric actuators. For example, the haptic controller (115) can provide haptic feedbacks in the form of vibrations, motions, forces, and the like, which can be customized based on the user's preferences. The haptic controller (115) can also be controlled by the microcontroller (103) based on the physiological signals received from the physiological sensor (101), such as heart rate, blood pressure, or skin conductance.

Further, the memory (117) of the wearable ring device (100) includes storage locations to be addressable through the microcontroller (103). The memory (117) is not limited to a volatile memory and/or a non-volatile memory. Further, the memory (117) can include one or more computer-readable storage media. The memory (117) can include non-volatile storage elements. For example, non-volatile storage elements can include magnetic hard discs, optical discs, floppy discs, flash memories, or forms of electrically programmable memories (EPROM) or electrically erasable and programmable (EEPROM) memories. The memory (117) can store the media streams such as input signals received from the physiological sensor (101), input received from the users of the wearable ring (100) and the like.

The I/O interface (119) transmits the information between the memory (117) and external peripheral devices. The peripheral devices are the input-output devices associated with the wearable ring device (100). The I/O interface (119) receives several information from the physiological sensors (101) and provides the output through the haptic controller (115).

The battery (121) of the wearable ring device (100) provides the power supply for functioning of the wearable ring device (100). Particularly, the battery (121) supplies power to the physiological sensor (101), microcontroller (103), wireless charging controller (105), NFC controller (109), the shared antenna (113) and the haptic controller (115) to perform its desired functionalities. The battery (121) ensures continuous operation of the wearable ring device (100). The battery (121) is made of lithium.

FIG. 2A-FIG. 2B is a schematic figure that illustrates a wearable ring device for wireless charging and secured NFC communication with a shared antenna operating with a controlled switching mechanism according to the disclosed embodiments. The wearable ring device (100) shown in FIG. 2A is designed to be worn of the users finger. The wearable ring device (100) includes a ring body that has an interior surface (125) and the exterior surface (123). The wearable ring device (100) is made of a metallic material non-metallic or semi metallic material. For example, the ring body can be made of metallic material such as Titanium, stainless steel, gold and the like. Also, the ring body can be made of non-metallic material such as ceramic and the like. The choice of material used to make the ring depends on the specific requirements of the device. For example, if the device needs to be lightweight and durable, a non-metallic material such as plastic or ceramic may be used. On the other hand, if the device needs to be strong and sturdy, a metallic material such as stainless steel or titanium may be used. The semi-metallic material can be used to provide a balance between strength and weight.

Also, the wearable ring device (100) can be worn by the users. The wearable ring is designed to be worn on a user's finger, making it a convenient and practical device. The ring can be worn all day without causing any discomfort or inconvenience to the user. The ring is also designed to be stylish and aesthetically pleasing, making it a fashionable accessory that can be worn with any outfit.

The wearable ring device (100) can be designed to be water-resistant or waterproof to allow for use in various environments. The wearable ring device (100) can also be designed to be adjustable to fit different finger sizes. The wearable ring device (100) can be connected to other devices such as smartphones, tablets, or computers using wireless communication protocols such as Bluetooth or Wi-Fi. The wearable ring device (100) can also be used in conjunction with other wearable ring device (100) such as smart watches or fitness trackers to provide a comprehensive set of functions to the user.

The interior surface (125) of the wearable ring device (100) is in contact with the user's finger, while the exterior surface is exposed to the environment (123). The interior surface (125) of the ring is designed to be comfortable and non-irritating to the user's skin, while the exterior surface (123) is designed to be durable and resistant to wear and tear.

For example, the wearable ring device (100) can be a smart ring that is comprising of a metal body. The smart ring is a type of wearable ring device (100) that is equipped with advanced features such as wireless charging and NFC communication. The metal body of the smart ring provides a strong and durable structure that can withstand the rigors of daily use. In an embodiment, the smart ring can be made using a ceramic material. The ceramic material provides a lightweight and durable structure that is ideal for wearable ring device (100).

The interior surface (125) of the wearable ring device (100) comprises the electronic components such as the shared antenna (113), the physiological sensor (101), the wireless charging controller (105), the NFC controller (109) and the microcontroller (103). Particularly, the shared antenna (125) is placed at the outer metal circumference of the inner surface (125) of the wearable ring device (100). The positioning of the shared antenna (125) is designed such that the NFC communication from the NFC controller (109) is not restricted. The wearable ring device (100) is equipped with a wireless charging mechanism that allows it to be charged without the need for cables or wires. The NFC controller (109) allows the wearable ring device (100) to securely communicate with other devices. The controlled switching mechanism ensures that the ring operates efficiently and effectively.

FIG. 2C is a schematic figure that illustrates the shared antenna and battery of the wearable ring to switch between the wireless charging controller and NFC controller according to the disclosed embodiments. The wearable ring device (100) includes a battery (121) that powers the ring's functions. The battery (121) can be a rechargeable battery that is charged wirelessly using the shared antenna (113). The shared antenna (113) can be positioned towards the palm-side of user finger particularly when the wearable ring device (100) is a finger ring, to optimize the wireless charging process.

The wearable ring device (100) includes the shared antenna (113) that is used for both wireless charging and the NFC communications. The shared antenna (113) performs the wireless charging of the wearable ring device (100) when the input signals are not received by the microcontroller (103) from the skin proximity sensor (101). The microcontroller (103) and the physiological sensor (101) is connected through a third connection. The skin proximity sensor (101) detects the presence of the user's skin and activates the wireless charging process. The shared antenna (113) can also perform the NFC communication when the input signals are received by the microcontroller (103) from the skin proximity sensor (101). The NFC communication is used in various applications such as contactless payments, asset tracking, healthcare, video games, identity and access, and the like.

The wearable ring device (100) includes a microcontroller (103) that controls the functions of the ring. The microcontroller (103) can be programmed to switch between the wireless charging and NFC communication modes based on the input signals received from the skin proximity sensor (101) via third connection. For example, the third connection can include, but not limited to CP4_B connection. The microcontroller (103) can also be programmed to perform other functions such as data storage, data processing, and data transmission. The wearable ring device (100) can also include additional sensors such as temperature sensors, pressure sensors, and motion sensors to provide additional functionality.

FIG. 2D is a schematic figure that illustrates the top view of the shared antenna in the wearable ring device, according to the disclosed embodiments. The shared antenna (113) is a loop shared antenna that is designed to operate at a frequency of 13.56 MHz, which is the frequency used for NFC communication. The loop shared antenna is made of a conductive material such as copper or aluminum and is positioned at an inner surface of the wearable ring (100) using a non-conductive adhesive.

The shared antenna (113) is positioned at the top of the metal part of the wearable ring (100) such that it is not obstructed by any other components of the ring. The metal part of the ring is made of a non-magnetic material such as stainless steel or titanium, which does not interfere with the magnetic field generated by the loop shared antenna. The shared antenna (113) is designed to have a high Q factor, which means that it has a narrow bandwidth and can efficiently transfer energy to and from the ring.

The shared antenna (113) is designed to perform dual NFC communication and wireless charging. The NFC communication allows the wearable ring device (100) to communicate with other NFC-enabled devices such as smartphones and payment terminals. The wireless charging allows the wearable ring device (100) to be charged without the need for any cables or connectors. The shared antenna (113) is connected to a wireless charging circuit that is designed to operate at a frequency of 13.56 MHz, which is the frequency used for wireless charging. The wireless charging controller (105) is connected to a power source such as a USB port or a wireless charging pad.

The strategic placement of the shared antenna (113) in the wearable ring device (100) ensures that the outer metal circumference of the ring does not restrict the NFC communication with the ring. The shared antenna (113) is designed to have a maximum communication range of up to 3 cm, which is sufficient for most NFC applications. The shared antenna (113) is also designed to have a high radiation efficiency, which means that it can transmit and receive signals with minimal loss. This ensures that the wearable ring device (100) can communicate with other NFC-enabled devices with high reliability and performance

FIG. 2E is a schematic figure that illustrates a cross-sectional view of the shared antenna in the wearable ring according to the disclosed embodiments. The shared antenna (113) is a thin, flexible strip of conductive material that is embedded within the wearable ring device (100). The shared antenna (113) is designed to operate at a specific frequency range and is optimized for wireless communication with other devices. The shared antenna (113) is also designed to be efficient, allowing for maximum signal strength and range. The shared antenna (113) is connected to a wireless charging circuit that is designed to operate at a frequency of 13.56 MHz, which is the frequency used for wireless charging. Also, the shared antenna (113) is designed to operate at a frequency of 13.56 MHz for NFC communication.

FIG. 2F is a schematic figure that illustrates the shared antenna region in the wearable ring device, according to the disclosed embodiments. The shared antenna region on the wearable ring device (100) is a specific area where the shared antenna (113) is placed. The shared antenna region is carefully chosen to ensure that the shared antenna (113) is able to operate at its optimal frequency range and is not interfered with by other components within the wearable ring (100). The shared antenna region is also designed to be easily accessible, allowing for easy connection to other devices. Also, FIG. 2F indicates the placement of the NFC controller (109) and the wireless charging controller (105) on the inner surface (125) of the wearable ring device (101). The NFC controller (109) and the wireless charging controller (105) is connected to the shared antenna (113).

FIG. 2G is a schematic figure that illustrates the skin proximity sensor region in the wearable ring according to the disclosed embodiments. The skin proximity sensor (101) is placed at the inner surface (125) of the wearable ring device (100). The skin proximity sensor is a small, sensitive sensor that is designed to detect the presence of skin in close proximity to the wearable ring device (100). The skin proximity sensor is typically used to detect when the wearable ring device (100) is being worn and can be used to trigger various functions or actions. The skin proximity sensor region is carefully chosen to ensure that the skin proximity sensor is able to operate at its optimal sensitivity and is not interfered with by other components within the wearable ring device (100).

FIG. 2H is a schematic figure that illustrates the NFC controller placed in the wearable ring device, according to the disclosed embodiments. The NFC controller (109) is a small, low-power integrated circuit that is designed to enable near-field communication (NFC) between the wearable ring device (100) and other NFC-enabled devices. The NFC controller (109) is typically used for contactless payments, data transfer, and other applications that require short-range wireless communication. The placement of the NFC controller (109) on the wearable ring device (100) is carefully chosen to ensure that it is easily accessible and able to operate at its optimal performance.

FIG. 2I is a schematic figure that illustrates the wireless charging controller on the wearable ring device according to the disclosed embodiments. The wireless charging controller (105) is a small, low-power integrated circuit that is designed to enable wireless charging of the wearable ring (100). The wireless charging controller (105) is typically used with a wireless charging pad or other charging device that is able to transmit power wirelessly to the wearable ring (100). The placement of the wireless charging controller (105) on the wearable ring (100) is carefully chosen to ensure that it is easily accessible and able to operate at its optimal performance.

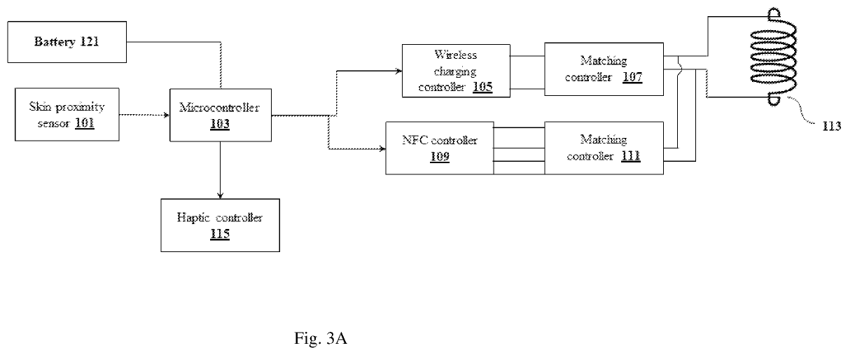

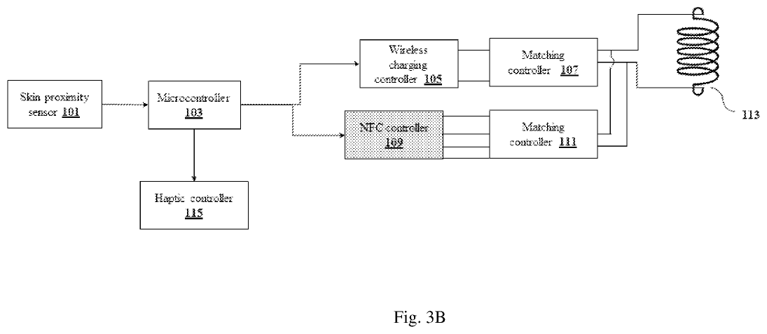

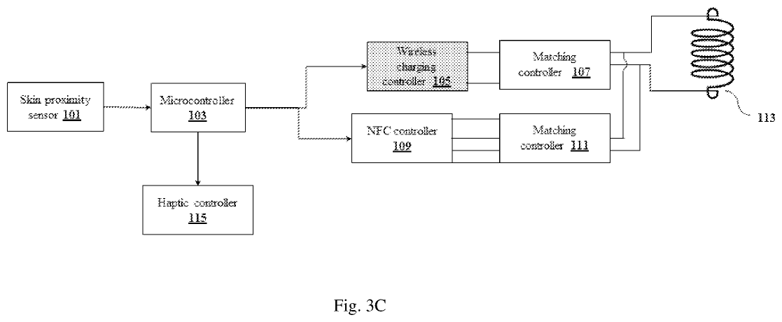

FIG. 3A is a schematic diagram that illustrates the circuit connection of the wearable ring device for wireless charging and secured NFC communication with a shared antenna operating with a controlled switching mechanism according to the disclosed embodiments. The wearable ring device (100) is designed to be worn on the skin and includes a skin proximity sensor (101) that is capable of detecting the presence of nearby objects, specifically the skin. The skin proximity sensor is connected to the microcontroller (103) through a third connection. For example, the third connection can include but not limited to a CP4-B connection. The skin proximity sensor sends the physiological signal to the microcontroller (103) through the third connection, when the skin proximity sensor detects the user is in contact with the wearable ring device (100). The microcontroller (103) is the central processing unit of the device and is responsible for controlling the various components. Upon receiving the physiological signals, the microcontroller (103) sends the control signals to the NFC controller (109) through the seventh connection to perform the NFC communication with an external NFC enabled device. For example, the seventh connection can be a N-SDA and N-SCL connections. The NFC controller (109) is enabled as shown in FIG. 3B. The NFC controller is enabled, by disabling the wireless charging controller (105) through the first connection. The NFC controller (109) receives the control signals from the microcontroller (103) through the two input pin connections. For example, the two pin connections can be RFI1 and RFI2 connections. The activation of the NFC controller is indicated in the FIG. 3B. Further, the NFC controller (109) performs the NFC communication with the external NFC enabled device using the shared antenna (113) through the matching controller (107). The NFC controller (105) sends the signals via two output pin connections to the matching controller (107). For example, two output pin connections can be a RFO1 and RFO2 connection. The matching controller (111) further matches the impedance of the shared antenna (113) to the impedance of the NFC controller (109) to perform the NFC communication. Upon impedance matching, the NFC communication is performed using the shared antenna (113). The matching controller (111) is connected to the shared antenna (113) via two terminal connections. For example, two terminal connections can be NANT1 and NANT2 connections. The matching controller (111) adjusts the impedance at the shared antenna (113) to ensure the maximum power transfer between the shared antenna (113) and the external NFC enabled device. Also, the matching controller (113) minimizes the reflections and enhances the efficiency. The shared antenna (113) generates a magnetic field and induces current in the receiving antenna associated with the external NFC enabled device when they are in close proximity, thus performing the NFC communication. For example, the NFC communication can be performed with payment terminals, transport ticketing terminals, and other compatible devices.

Also, the physiological sensor (101) does not send physiological signals to the microcontroller (103), when the user is not in the proximity of the wearable ring device (100). Further, the microcontroller (103) sends the control signals to the wireless charging controller (105) through the first communication link and to enable the wireless charging mode of the wearable ring device (100). For example, the first communication link can include but not limited to PMIC-SDA and PMIC-SCL connection. The enablement of the wireless charging controller (105) is as shown in FIG. 3C. Further, the Wireless charging controller (105) initiates the wireless charging of the wearable ring device (100) through the shared antenna (113). For initiating, the wireless charging controller (105) sends the signals to the matching controller (107) through the two pin connections. For example, two pin connections can be a RF1 and RF2 connection indicating to initiate the charging process. The matching controller (107) is used for optimizing the impedance matching between the shared antenna (113) and the wireless charging controller (105). Further, the matching controller (107) adjusts the impedance at the shared antenna (113) to ensure the maximum power transfer for charging the wearable ring device (100). Upon impedance matching, the matching controller (107) enables the shared antenna (113) through two terminal connections to initiate the charging of the wearable ring device (100). For example, two terminal connections can be NANT1 and NANT2 connection.

Also, the microcontroller (103) sends the control signals to the haptic controller (115) through the first communication to provide the haptic feedback. The first communication link can be used for I2C communication. The haptic feedback provided by the haptic controller (115) indicates the enabling or disabling of the at least one wireless charging mode or NFC communication mode in the wearable ring device (100). For example, the haptic feedback can be in the form of vibrations. Also, the haptic controller (115) signals the microcontroller (103) of various signals like the completion of a haptic event, or any event detected via a second communication link.

The proposed wearable ring device (100) includes a range of components that work together to provide a seamless user experience. The skin proximity sensor (101) detects the presence of the skin, while the wireless charging controller (105) and NFC controller (109) enable wireless charging and communication with other devices. The Haptic controller (115) provides feedback to the user, and the microcontroller (103) controls all of these components.

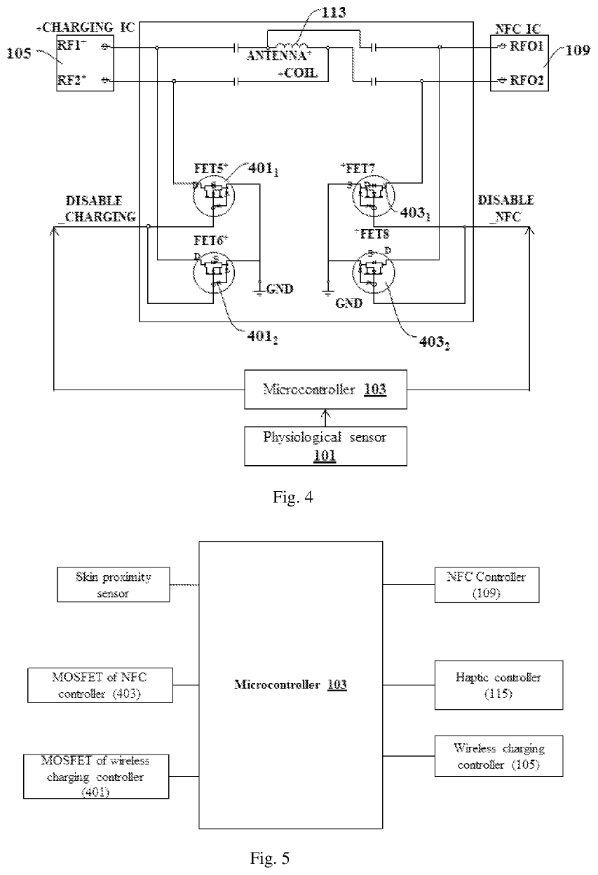

FIG. 4 is a circuit diagram that illustrates a wearable ring device for wireless charging and secured NFC communication with a shared antenna operating with a controlled switching mechanism, according to the disclosed embodiments.

The wearable ring device (100) includes a microcontroller (103) that receives physiological signals from the skin proximity sensor (101). The microcontroller (103) controls the circuit switches/MOSFET switches (401, 403) to disable the wireless charging controller (105) and the NFC controller (109) respectively, based on the input signals received from the skin proximity sensor (101). The circuit switch (401) associated with wireless charging controller (105) comprises two MOSFET switches (401₁ and 401₂) that are connected to the two ends of the shared antenna (113). Similarly, the circuit switch (403) comprises two MOSFET switches (403₁ and 403₂) that are connected to the two ends of the shared antenna (113). Further, based on the control signals received from the microcontroller (103), the circuit switch (401) or circuit switch (403) are disabled. Particularly, when there are no physiological signals received from the skin proximity sensor, then the circuit switch (403) associated with the NFC controller (109) is disabled via a second connection and the circuit switch (401) is enabled to perform the wireless charging using the shared antenna (113). The second connection can include, but not limited to a DISABLE-PAY connection. Also, when there is an input signal received from the skin proximity sensor, then the circuit switch (403) associated with wireless charging controller (109) is disabled via a first connection and the circuit switch (401) is enabled to perform the NFC communication through the shared antenna (113). The first connection can include, but not limited to a DISABLE-CHRG connection.

The wireless charging controller (105) in the wearable ring device (100) is designed to receive power wirelessly from a charging pad. The wireless charging controller (105) includes a rectifier circuit that converts the AC power received from the charging pad to DC power. The DC power is then used to charge the battery in the wearable ring device (100). The wireless charging controller (105) is disabled when the input signals are received by the microcontroller (103) from the skin proximity sensor (101). The circuit switch (401) is then automatically enabled to perform wireless charging through the shared antenna (113).

The NFC controller (109) in the wearable ring device (100) is designed to communicate with other NFC-enabled devices. The NFC controller (109) includes a modulator circuit that modulates the data to be transmitted onto a carrier signal. The modulated signal is then transmitted through the shared antenna (113) to the other NFC-enabled device. The NFC controller (109) is disabled when there are no input signals received by the microcontroller (103) from the skin proximity sensor (101). The circuit switch (403) is then automatically enabled to perform NFC communication through the shared antenna (113).

The skin proximity sensor (101) in the wearable ring device (100) is designed to detect the presence of skin in close proximity to the device. The skin proximity sensor (101) includes a capacitive sensor that measures the capacitance of the skin. When the skin is in close proximity to the sensor, the capacitance increases. The skin proximity sensor (101) sends input signals to the microcontroller (103) based on the measured capacitance. The microcontroller (103) then controls the circuit switches (401, 403) to enable or disable the wireless charging controller (105) and the NFC controller (109) based on the input signals received from the skin proximity sensor (101).

As shown in FIG. 4, the circuit contains the first 2 MOSFETs-FET7 (403₁) and FET8 (403₂) connected between each of the shared antenna (113) connections of NFC Controller (109) and Ground. The connection between the MOSFETs (403) and the NFC controller (109) is alternatively referred to as fifth connection. Further, 2 MOSFETs-FET5 (401₁) and FET6 (401₂) are connected between each of the shared antenna (113) connections of Wireless Charging controller (105) (RF1 & RF2) and Ground. The connection between the MOSFETs (401) and the wireless charging controller (105) is referred to as fourth connection. Further, the Gates of the FET5 (401₁) & FET6 (401₂) are connected to the microcontroller (103) via the first connection. Similarly, the Gate of the FET7 & FET8 (403) are connected to the microcontroller (103) via the second connection. A third connection connects the microcontroller (103) to the physiological sensor (101).

Further, when the physiological sensor's (101) output is on, the microcontroller (103) detects that the ring is on the finger and sends a signal to FET5 (401₁) & FET6 (401₂) via the first connection. This applies a signal to the gate of the FETs and signals the FET5 (401₁) & FET6 (401₂) to turn on, thus pulling RF1 and RF2 to ground, making the wireless charging controller's antenna circuitry inoperative. The NFC controller (109) takes full control of the shared antenna (113) and is able to communicate with an external device.

Further, when the physiological sensor's (101) output is off, the microcontroller (103) detects that the ring is off the finger and sends a signal to FET7 (403₁) & FET8 (403₂) via the second connection. This applies a signal to the gate of the FETs and signals the FET 7 (403₁) & FET 8 (403₂) to turn on, thus pulling RFO1 and RFO2 to ground. The microcontroller (103) also disables the signal to the first connection, which releases the FET5 (401₁) & FET6 (403₁). As a result, the wireless charging controller (105) takes full control of the shared antenna (113) and is ready for charging.

FIG. 5 is a block diagram that illustrates a microcontroller for controlling the switching between wireless charging and NFC communication with a shared antenna according to the disclosed embodiments. The microcontroller (103) is a low-power device that is capable of performing complex operations. It is designed to operate at a low voltage and consume minimal power. The skin proximity sensor (101) is a capacitive sensor that detects the presence of a user's skin and triggers the microcontroller (103) to switch between wireless charging and NFC communication modes.

FIG. 5 illustrates the pin connections of the microcontroller (103) with the skin proximity sensor (101), wireless charging controller (105), NFC controller (109), and the Haptic controller (115). The microcontroller (103) receives the voltage supply through the eight connection for performing the operations. For example, the eighth connection can be a VDD connection. The wireless charging controller (105) is connected to the microcontroller (103) through the first communication link, which are used for I2C communication. The wireless charging controller (105) is a device that generates an electromagnetic field to transfer energy wirelessly to a compatible device. The NFC controller (109) is connected to the microcontroller (103) through the seventh connection. The NFC controller (109) enables communication between two devices in close proximity The microcontroller (103) sends signals to the NFC controller (109) through the seventh connections.

Particularly, the skin proximity sensor (101) is connected to the microcontroller (103) through the third connection. This connection is designed to provide a high signal-to-noise ratio and reduce interference from other sources. The Haptic controller (115) is connected to the microcontroller (103) through the first communication link, which are used for I2C communication. The haptic controller (115) is a device that provides tactile feedback to the user. Also, the haptic controller (115) is also connected to the microcontroller (103) through HAP-GPIO (519) connection. The microcontroller (103) performs controlling signal interfaces, signal modulation, feedback monitoring and power management through the second communication link connection. The Haptic controller (115) is triggered by the microcontroller (103) to provide feedback to the user when the wearable ring device (100) switches between wireless charging and NFC communication modes.

Also, the first communication link are used for I2C communication. I2C is a communication protocol that enables devices to exchange data with each other. It is a two-wire interface that uses a clock signal and a data signal to transmit information. The first communication link are used to communicate with the wireless charging controller (105), and the Haptic controller (115). The microcontroller (103) uses these connections to control the switching between wireless charging and NFC communication modes and to provide feedback to the user through the Haptic controller (115). Further, the microcontroller (103) is connected to the MOSFET switches (401) of the wireless charging controller (105) through the first connection. Also, the microcontroller (103) is connected to the MOSFET switches (403) of the NFC controller (109) through the second connection. The microcontroller (103) disables the NFC controller (109) through the first connection when the input signals are not received from the skin proximity sensor (101) through the third connection. Similarly, the microcontroller (103) disables the wireless charging controller (105) through the first connection when the input signals are received from the skin proximity sensor (101) through the third connection.

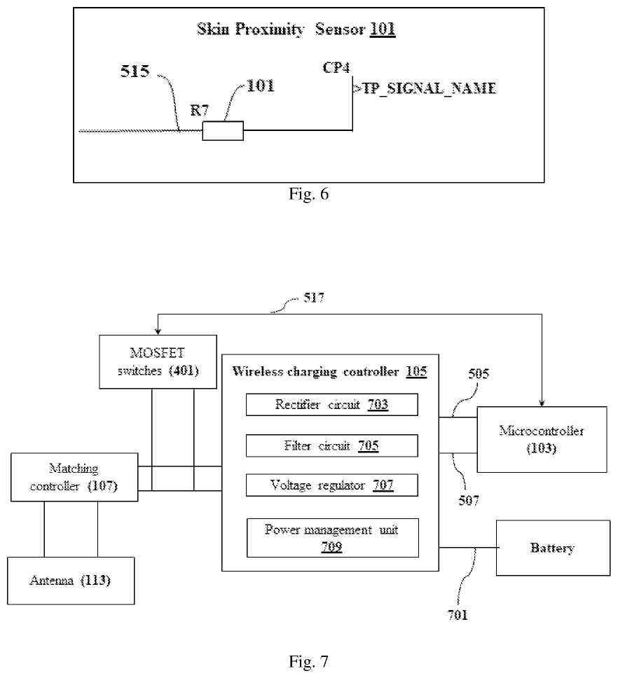

FIG. 6 is a circuit diagram that illustrates the connection of the skin proximity sensor with the microcontroller, according to the disclosed embodiments.

The skin proximity sensor (101) is a capacitive sensor that detects the presence of a user's skin. The skin proximity sensor (101) is communicated with the microcontroller (103) through the third connection, which is a digital communication interface. The skin proximity sensor (101) provides an input to the microcontroller (103) whether the wearable ring device (100) is in detectable range with the user associated with the wearable ring device (100) or is away or in non-detectable range from the user associated with wearable ring device (100). The detectable range for the skin proximity sensor is 3 cm.

Particularly when the wearable ring device (100) is away or is in non-detectable range from the user, then no input signals are provided to the microcontroller (103) that indicates the microcontroller (103) to enable the wireless charging controller (105) to perform the wireless charging of the wearable ring device (100). The wireless charging controller (105) is a power management IC that receives power from a wireless charging pad and charges the battery of the wearable ring device (100). The wireless charging controller (105) is disabled by the microcontroller (103) when the wearable ring device (100) is not in use to conserve power.

Similarly, when the wearable ring device (100) is in the detectable range of the skin proximity sensor (101), then the input signals are provided to the microcontroller (103) that indicates to disable the wireless charging controller (105) and enable the NFC controller (109) to perform the NFC communications. The NFC controller (109) is a communication IC that enables the wearable ring device (100) to communicate with other NFC-enabled devices. The NFC controller (109) is enabled by the microcontroller (103) when the wearable ring device (100) is in use and in close proximity to another NFC-enabled device.

FIG. 7 is a block diagram that illustrates the wireless charging controller connected to the microcontroller, according to the disclosed embodiments. The wireless charging controller (105) comprises a rectifier circuit (703), a filter circuit (705), a voltage regulator (707) and a power management unit (709). The rectifier circuit (703) rectifies an AC voltage received from a wireless power transmitter. The rectifier circuit (703) includes diodes that rectify the AC voltage. Particularly, the rectifier circuit (703) coverts the AC signal into a stable DC voltage that is suitable for charging battery (121) of the wearable ring device (100). Further, the filter circuit (705) filters the rectified voltage to remove high frequency noise. The filter circuit (705) includes the capacitor that filter out the high-frequency noise. The filter circuit (705) ensures reliable and efficient operation of the wireless charging of the wearable ring device (100). The voltage regulator (707) regulates the filtered voltage to a constant level. The power management unit (709) regulates the AC voltage received from a wireless power transmitter. Also, the PMU (709) monitors the status of the battery (121) of the wearable ring device (100). Also, the PMU detects whether the battery is being fully charged based on the monitored status of the battery. Also, the PMU (709) deactivates the wireless charging of the wearable ring device (100) to prevent overcharging, when the battery is being fully charged. The PMU is designed to regulate the voltage and current received from the wireless charger to ensure that the battery is charged safely and efficiently. The PMU is also used to monitor the battery status and control the charging process. The PMU is controlled by the microcontroller (103) based on the operation mode selected by the user. When the user selects the wireless charging mode, the PMU is turned on, and the wireless charging process is initiated. When the battery is fully charged, the PMU turns off the wireless charging process to prevent overcharging.

During charging, the wireless charging controller's (105) internal antenna circuitry has access to the shared antenna (113) through the first matching circuit (107). The matching circuit (107) optimizes the efficiency of power transfer from the shared antenna (113) into the wireless charging controller (105). The internal circuitry of the wireless charging controller (105) rectifies the voltage and charges the battery via its charging circuitry.

The wireless charging controller (105) includes a matching circuit (107) that is connected to a shared antenna (113). The wireless charging controller (105) is connected to the battery (121) of the wearable ring device (100) through the sixth connection. The wireless charging controller (105) is connected to the microcontroller (103) through the first communication link. The wireless charging controller (105) receives the signal from the microcontroller (103) through first communication link to enable the wireless charging of the wearable ring device (100). Also, the wireless charging controller (105) is connected to the MOSTFET switches (401) through the first connection to disable the wireless charging of the wearable ring device (100). The disabling can be performed by putting the MOSFET switches (401) to ground or keeping the outputs of the MOSFET switches (401) open. Further, the wireless charging controller (105) is connected to the matching circuit (107) through the two pin connections. Further the matching circuit (107) is connected to the shared antenna (113) through the two terminal connections. When the wireless charging controller (105) is enabled, then the wireless charging controller (105) performs the charging of the wearable ring device (100) using the shared antenna (113) through the two terminal connections.

The microcontroller (103) in FIG. 7 controls the wireless charging operation by communicating with the wireless charging controller (105) and the NFC controller (109). The microcontroller (103) sends control signals to the MOSFET switches (403) of the NFC controller (109) to disable the NFC communication and enable the wireless charging operation. The microcontroller (103) also receives feedback signals from the wireless charging controller (105) to monitor the charging status and adjust the charging parameters. The microcontroller (103) includes a processor and memory that store the control and feedback signals.

The shared antenna (113) in FIG. 7 is used for both NFC communication and wireless charging. The shared antenna (113) is designed to operate at a frequency range of 13.56 MHz for NFC communication for the wireless charging. The shared antenna (113) is used to switch between the two operations by controlling the MOSFET switches (401, 403) of the wireless charging controller (105) and the NFC controller (109). The shared antenna (113) is a loop shared antenna that is designed to generate a magnetic field for wireless charging and an electromagnetic field for NFC communication. The shared antenna (113) is made of a conductive material such as copper or aluminum.

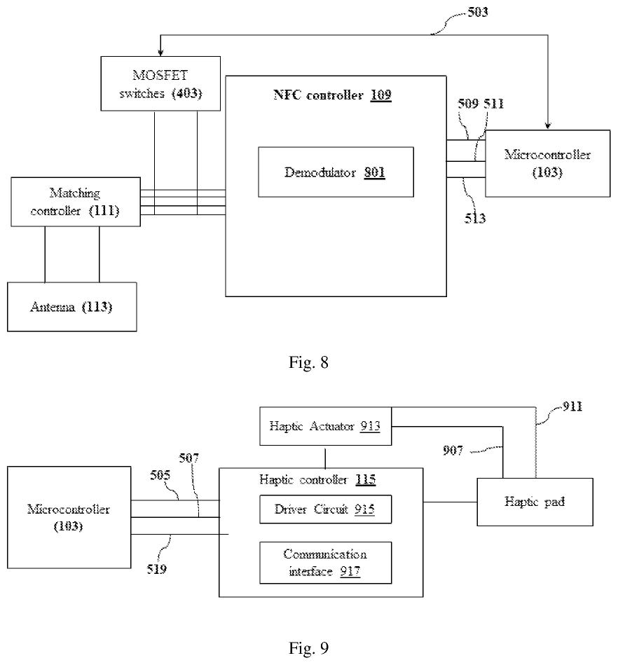

FIG. 8 is a block diagram that illustrates the NFC controller connected to the microcontroller, according to the disclosed embodiments. The NFC controller (109) comprises a demodulator (801) that demodulates the received signal from the shared antenna (113). Also, the demodulator (801) extracts data from the received signal and send the extracted data to the microcontroller (103) for further processing. Further, the demodulator (801) modulates the data to be transmitted to the shared antenna (113) during the NFC communication by changing an amplitude or phase of a scarier signal.

The NFC controller (109) receives input voltage (for example, 3.3V) to perform the NFC operation. The NFC controller (109) is connected to the matching controller (111) that receives the input through the two input pin connection and provides the output through the two output pin connection. The matching controller (111) are further connected to the antenna (113) through the two terminal connection. The NFC controller (109) performs the NFC communication through the shared antenna (113), when the NFC controller (109) is enabled by the microcontroller (103) through the seventh connections. Also, the NFC controller (109) receives disable signals from the microcontroller (103) through the second connection. Upon receiving the disable signals, the MOSFET switches (403) are put to ground or the outputs of the MOSFET switches (403) are kept open. The NFC controller (109) performs the NFC communication through the common antenna (113).

The MOSFET switches (403) helps in switching from the wireless charging controller (105) to the NFC controller (109). The controlling of the MOSFET switches (403) of the wireless charging controller (105) includes making the outputs of the wireless charging controller (105) open or putting MOSFET switches to ground so that the wireless charging controller (105) is disabled. The MOSFET switches (403) are controlled by the microcontroller (103) based on the operation mode selected by the user. When the user selects the NFC mode, the MOSFET switches (401) are turned off, and the wireless charging controller (105) is disabled. When the user selects the wireless charging mode, the MOSFET switches (401) are turned on, and the wireless charging controller (105) is enabled.

FIG. 9 is a block diagram that illustrates the Haptic controller connected to the microcontroller, according to the disclosed embodiments.

The Haptic controller (115) comprises, a driver circuit (915) and the communication interface (917). The haptic controller (115) is associated with haptic actuator (913) that is connected to the haptic pad. The haptic actuator (913) generates vibrations of different intensities and frequencies based on inputs received from the microcontroller (103). Further, the driver circuit (915) amplifies signals from the microcontroller (103) to drive the vibration motor. Also, the communication interface (917) is an interface between haptic controller (115) and the microcontroller (103) that comprises pins configured to transmit and receive digital signals encoded using the specified protocol. The pins are configured to transmit and receive digital signals that carry information about the operations performed at the wireless charging controller (105) or the NFC controller (109). The digital signals are encoded using a specific protocol that ensures reliable and secure communication between the microcontroller (103) and the Haptic controller (115). For example, the specific protocol can be I2C, UART, SPI protocols and the like. The microcontroller (103) continuously monitors the signal from the physiological sensor and alters the operating state of the device from charging to NFC communication and vice versa. When the operating state is altered, the microcontroller (103) communicates to the haptic controller (115) via the first communication link to send a haptic vibration to the user. Upon completion of the haptic feedback, the haptic controller signals to the microcontroller (103) via second communication link thus making the feedback loop complete.

The haptic controller (115) receives input voltage for its operation through ninth connections. For example the ninth connection can be a RP/VDO, VBUS and VDDP. Further, the haptic controller (115) is connected to the microcontroller (103) through the first communication link. The haptic controller (115) receives the signals indicating the activation of wireless charging or deactivation of wireless charging. The haptic controller (115) provides the haptic feedback to the users through the haptic actuators (913) that is connected to haptic pad using tenth connection second communication link. For example, the tenth connection can be a HAP+ (907) and HAP− (911) pin connections. The HAP+ (907) and HAP− (911) pins are connected to haptic pads, that generates the vibrations to indicate the activation of wireless charging and deactivation of wireless charging of the wearable ring (100). The haptic feedback can be given through vibrations. Also, the haptic controller (115) is connected to the microcontroller (103) through the second communication link that can be used for controlling the signal interfaces, signal modulation, feedback monitoring and power management.

The Haptic controller (115) receives the input from the microcontroller (103) about the operations performed at the wireless charging controller (105) or the NFC controller (109) and accordingly provides the feedback to the user associated with the wearable ring (100). The feedback can be customized based on the user's preferences and the type of operation performed. For example, the haptic controller (115) can generate a short and gentle vibration to indicate the activation and deactivation of the wireless charging. Similarly, if the NFC controller (109) detects a valid transaction, the Haptic controller (115) can generate a series of vibrations to indicate the successful completion of the transaction.

The haptic feedback can be in the form of vibrations. The vibrations generated by the Haptic controller (115) can be of different types, such as continuous, pulsating, or intermittent, depending on the type of feedback required. The haptic feedback can also be synchronized with other sensory inputs, such as visual or auditory cues, to enhance the user experience and the usability of the wearable ring (100).

In an embodiment, the first connection, second connection, third connection, fourth connection, fifth connection, sixth connection, seventh connection, eight connection, ninth connection, tenth connection, first communication link and second communication link can be wired connections.

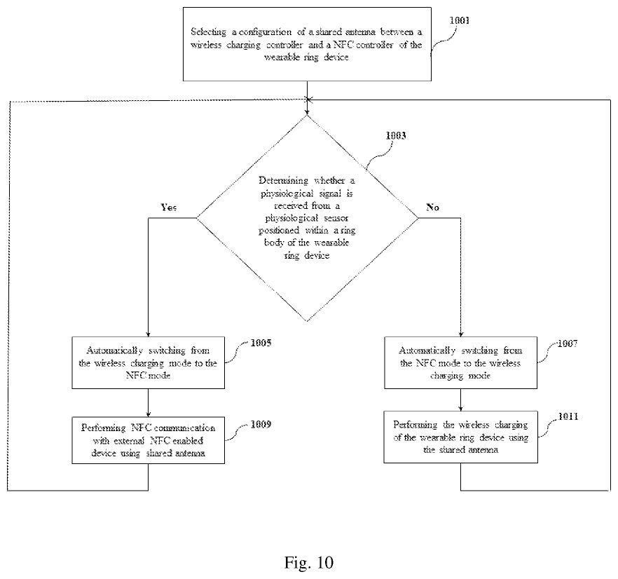

FIG. 10 is a flow diagram that illustrates a method for wireless charging and secured NFC communication with a shared antenna operating with a controlled switching mechanism according to the disclosed embodiments.

At block 1001, the method includes selecting a configuration of a shared antenna between a wireless charging controller (105) and a NFC controller (109) of the wearable ring device (100).

At block 1003, the method includes determining whether the physiological signal is received from a physiological sensor (101) positioned within a ring body of the wearable ring device (100). The reception of the physiological signal indicates that the wearable ring device (100) is worn on a finger of a user of the wearable ring device (100).

At block 1005, the method includes automatically switching from the wireless charging mode to the NFC mode, when the physiological signal is received from the physiological sensor (101).

Further at block 1009, the method includes performing by the wearable ring device the NFC communication with external NFC-enabled devices using the shared antenna.

At block 1007, the method includes automatically switching from the NFC mode to the wireless charging mode, when the physiological signal is not received from the physiological sensor. Upon operating in the NFC mode, the method continues to detect the physiological signals being received from the physiological sensor (101).

At block 1111, the method includes performing the wireless charging of the wearable ring device (100) using the shared antenna (113) between the wireless charging controller (105) and the NFC controller (109). Upon operating in the wireless charging mode, the method continues to detect the physiological signals being received from the physiological sensor (101).

The various actions, acts, blocks, steps, or the like in the method are performed in the order presented, in a different order, or simultaneously. Furthermore, in some embodiments, some of the actions, acts, blocks, steps, or the like are omitted, added, modified, skipped, or the like without departing from the scope of the proposed method.

The foregoing description of the specific embodiments will fully reveal the general nature of the embodiments herein such that others can readily modify and/or adapt such specific embodiments for various applications without departing from the generic concept. Therefore, such adaptations and modifications are intended to be comprehended within the meaning and range of equivalents of the disclosed embodiments. It is to be understood that the phraseology or terminology employed herein is for the purpose of description and not of limitation. Thus, while the embodiments herein have been described in terms of preferred embodiments, those skilled in the art will recognize that the embodiments herein can be practiced with modifications within the scope of the embodiments as described herein.

What is claimed is:

1. A wearable ring device for managing wireless charging and NFC communication, comprising:
a ring body adapted to be worn on a finger of a user, wherein the ring body having an interior surface and an exterior surface;
a shared antenna placed at the interior surface of the ring body, wherein the shared antenna is configured to perform both the NFC communication and wireless charging;
a physiological sensor configured to detect whether the wearable ring device is worn on the finger of the user;
a wireless charging controller that performs the wireless charging of the wearable ring device in a wireless charging mode using the shared antenna;
an NFC controller that performs the NFC communication with external NFC-enabled devices in a NFC communication mode using the shared antenna; and
a microcontroller connected to the physiological sensor, the wireless charging controller, NFC controller, and the shared antenna, wherein the microcontroller controls switching between the wireless charging mode and the NFC communication modes based on reception of the physiological signal from the physiological sensor, and performs one of the wireless charging of the wearable ring device using the shared antenna or the NFC communication with the external NFC-enabled devices using the shared antenna.

2. The wearable ring device as claimed in claim 1, control switching between the wireless charging mode and the NFC communication mode based on the physiological signal is received from the physiological sensor comprises:
determines whether the physiological signal is received from the physiological sensor, wherein the reception of the physiological signal indicates that the wearable ring device is worn on the finger of the user; and
automatically switches from the wireless charging mode to the NFC mode and perform the NFC communication with the external NFC-enabled devices using the shared antenna, when the physiological signal is received from the physiological sensor, or
automatically switches from the NFC mode to the wireless charging mode and perform the wireless charging of the wearable ring device using the shared antenna, when the physiological signal is not received from the physiological sensor.

3. The wearable ring device as claimed in claim 2, wherein automatically switch from the wireless charging mode to the NFC mode comprises automatically disabling the wireless charging controller and enable the NFC controller to perform the NFC communication using the shared antenna.

4. The wearable ring device as claimed in claim 2, wherein automatically switch from the NFC mode to the wireless charging mode comprises automatically disable the NFC controller and enable the wireless charging controller to perform the wireless charging using the shared antenna.

5. The wearable ring device as claimed in claim 1, wherein the shared antenna is oriented towards a opposite side of the finger of the user of the wearable ring device, and wherein position and orientation of the shared antenna maximizes a signal strength of the shared antenna during the NFC communication while minimizing exposure to external interferences.

6. The wearable ring device as claimed in claim 1, wherein the physiological sensor comprises at least one of an optical-based skin sensor, a capacitance-based skin sensor, an inductance based skin sensor, and a force-based skin sensor.

7. The wearable ring device as claimed in claim 1, comprises:
a haptic controller connected to the microcontroller, wherein the haptic controller receives input signals from the microcontroller when the microcontroller switches between the NFC mode and the wireless charging mode and generates a haptic feedback for the user regarding the switching based on the received input signals;
a memory connected to the microcontroller, wherein the memory stores information related to the wireless charging and NFC communication modes;
a battery of the wearable ring device connected to the wireless charging controller via a sixth connection; and
an actuator connected to the microcontroller, wherein the actuator for manual activation or deactivation of the wireless charging mode and the NFC communication mode.

8. The wearable ring device as claimed in claim 7, comprising:
a first connection that operatively connects gates of MOSFETs associated with the wireless charging controller with the microcontroller, wherein the MOSFETs is controlled by the microcontroller based on the physiological signals received from the physiological sensors;
a second connection that operatively connects gates of the MOSFETs associated with NFC controller with the microcontroller, wherein the MOSFETs is controlled by the microcontroller based on the physiological signals received from the physiological sensors;
a third connection that operatively connects the microcontroller to the physiological sensor;
a fourth connection that operatively connects the MOSFETs associated with the wireless charging controller to the shared antenna;
a fifth connection that operatively connects the MOSFETs associated with the NFC controller to the shared antenna;
wherein when the physiological signals are not received from the physiological sensor via the third connection, the microcontroller disables the NFC controller via the second connection and turns on the MOSFET switches, thereby disabling antenna portion of the NFC controller and enabling wireless charging controller by opening its antenna connection through the fourth connection;
wherein, when input signals are received from the physiological sensor via the third connection, the microcontroller disables the wireless charging controller via the first connection and turns off the MOSFET switches by putting the MOSFET switches to ground, thereby disabling the antenna portion of the wireless charging controller and enabling the NFC controller by opening its antenna connection through fifth connection.

9. The wearable ring device as claimed in claim 8, comprising:
a first communication link that operably connects the haptic controller to the microcontroller, wherein the first communication link is configured to enable I2C communication between the microcontroller, the wireless charging controller, and the haptic controller; and
a second communication link is connected from the haptic controller to the microcontroller, wherein the haptic controller signals the microcontroller of various signals like the completion of a haptic event, or any event detected by the haptic controller. and
wherein the wireless charging controller is configured to receive signals from the microcontroller via the first communication link or second communication link to enable the wireless charging of the wearable ring device, and to disable the wireless charging and enable the NFC communication.

10. The wearable ring device as claimed in claim 1, comprises:
a first matching circuit connected to the wireless charging controller through two pin connections, wherein the first matching circuit is further connected to the shared antenna through two terminal connections, wherein the first matching circuit optimizes impedance matching between a shared antenna and the wireless charging controller, and wherein the first matching circuit controls efficient transfer of power between the shared antenna and the wireless charging controller; and
a second matching circuit connected to the NFC controller through 4 pin connections, wherein the second matching circuit is further connected to the shared antenna through terminal connection, wherein the second matching circuit controls efficient transfer of data between the shared antenna and the NFC controller, and wherein the second matching circuits configured to receive input and output through the 4 pin connections;
wherein, when enabled, the wireless charging controller performs charging of the wearable ring device using the shared antenna through the two terminal connections.

11. The wearable ring device as claimed in claim 1, wherein the wireless charging controller comprises:
a rectifier circuit configured to rectify an AC voltage received from a wireless power transmitter, wherein the rectifier circuit includes diodes that rectify the AC voltage;
a filter circuit configured to filter the rectified voltage to remove high-frequency noise, wherein the filter circuit including capacitors that filter out the high-frequency noise; and
a voltage regulator configured to regulate the filtered voltage to a constant level.

12. The wearable ring device as claimed in claim 11, wherein the wireless charging controller comprises a power management unit (PMU) configured to:
regulate the AC voltage received from a wireless power transmitter;
monitor a status of a battery of the wearable ring device; and
detect whether the battery being fully charged based on the monitored status of the battery; and
deactivate the wireless charging of the wearable ring device to prevent overcharging, when the battery being fully charged.

13. The wearable ring device as claimed in claim 1, wherein the NFC controller comprises a demodulator configured to:
demodulate a received signal from the shared antenna;
extract data from the received signal and send the extracted data to a microcontroller for further processing; and
modulate data to be transmitted to the shared antenna during the NFC communication by changing an amplitude or phase of a carrier signal.

14. The wearable ring device as claimed in claim 7, wherein the haptic controller comprises:
a haptic actuator that generates vibrations of different intensities and frequencies based on input received from the microcontroller;
a driver circuit that amplifies signals from the microcontroller to drive the vibration motor; and
a dedicated bidirectional communication interface between the haptic controller and the microcontroller, comprising multiple pins configured to transmit and receive digital signals encoded using a specific protocol.

15. The wearable ring device as claimed in claim 1, wherein the shared antenna is having a communication range of 3 centimeter.

16. The wearable ring device as claimed in claim 1, wherein the shared antenna operates at a frequency of 13.56 MHz to perform the wireless charging of the wearable ring device.

17. The wearable ring device as claimed in claim 1, wherein the shared antenna operates at a frequency of 13.56 MHz to perform the NFC communication with the external NFC-enabled devices.

18. The wearable ring device as claimed in claim 1, wherein the ring body is constructed from a fully metallic material or a partially metallic material or a non-metal.

19. A method for managing wireless charging and NFC communication, comprising:
selecting, by a wearable ring device, a configuration of a shared antenna between a wireless charging controller and a NFC controller of the wearable ring device;
determining, by the wearable ring device, whether a physiological signal is received from a physiological sensor positioned within a ring body of the wearable ring device, wherein reception of the physiological signal indicates that the wearable ring device is worn on a finger of a user of the wearable ring device; and
automatically switching, by the wearable ring device, from the wireless charging mode to the NFC mode and performing by the wearable ring device the NFC communication with external NFC-enabled devices using the shared antenna, when the physiological signal is received from the physiological sensor, or
automatically switching, by the wearable ring device, from the NFC mode to the wireless charging mode and performing the wireless charging of the wearable ring device using the shared antenna between the wireless charging controller and the NFC controller, when the physiological signal is not received from the physiological sensor.

20. The method as claimed in claim 18, wherein automatically switching from the wireless charging mode to the NFC mode comprises automatically disabling the wireless charging controller and enabling the NFC controller to perform the NFC communication using the shared antenna, and
wherein automatically switching from the NFC mode to the wireless charging mode comprises automatically disabling the NFC controller and enable the wireless charging controller to perform the wireless charging using the shared antenna.

21. The method as claimed in claim 19, wherein automatically switching from the wireless charging mode to the NFC communication is based on at least one of
detecting and generating a haptic feedback signal through the second communication link when the haptic actuator is pressed by the user; or
receiving an external input from the user using the I/O interface.
